(19) United States
(12) Patent Application Publication
(10) Pub. No.: US 2014/0298591 A1
(43) Pub. Date: Oct. 9, 2014

(54) USE OF COMB OR BLOCK COPOLYMERS AS SOIL ANTIREDEPOSITION AGENTS AND SOIL RELEASE AGENTS IN LAUNDRY PROCESSES

(71) Applicants: BASF SE, Ludwigshafen (DE); Henkel Ag & Co. KGAA, Düsseldorf (DE)

(72) Inventors: Menno Hazenkamp, Riehen (CH); Frank Oliver Heinrich Pirrung, Grunstadt (DE); Dario Perera, Basel (CH); Paula Barreleiro, Dusseldorf (DE); Christa Junkes, Dusseldorf (DE); Wolfgang von Rybinski, Dusseldorf (DE)

(21) Appl. No.: 14/354,008

(22) PCT Filed: Oct. 24, 2012
(86) PCT No.: PCT/EP2012/071020

§ 371 Date: Apr. 24, 2014

Related U.S. Application Data
(60) Provisional application No. 61/550,936, filed on Oct. 25, 2011.

(30) Foreign Application Priority Data
Oct. 25, 2011 (EP) 11186446.8

(51) Int. Cl. C11D 3/00

(52) U.S. Cl. CPC C11D 3/0036
USPC 8/137; 510/400

(57) ABSTRACT

The present invention relates to the use of comb or block copolymers which have been prepared by controlled free radical polymerization as soil antiredeposition agents and soil release agents in laundry processes. Further aspects of the invention are a method for preventing soil redeposition and for easier releasing soil from textiles in laundry processes and detergent formulations containing said comb or block copolymers.

The present invention relates to the use of comb or block copolymers which have been prepared by controlled free radical polymerization as soil antiredeposition agents and soil release agents in laundry processes. Further aspects of the invention are a method for preventing soil redeposition and for easier releasing soil from textiles in laundry processes and detergent formulations containing said comb or block copolymers.

In customary household washing methods, soil may, after being released from the dirty textiles into the wash liquor, be again re-deposited on the textiles, especially when using suboptimal detergent formulations and/or at lower wash temperatures. A graying of the laundry becomes in this case apparent after multi-cycle washing. A further problem is that some types of soil and dirt are difficult to remove from textiles when using suboptimal detergent formulations and/or at lower wash temperatures, because these soils and dirt are strongly attached to the fiber surface or are strongly absorbed inside the fibers.

The use of several agents as soil antiredeposition agents and soil release agents in laundry processes is known. Examples are carboxymethyl cellulose or anionic derivatives of polymers from terephthalic acid and polyethylene glycol (see e.g. E. Smulders in “Laundry Detergents” Wiley-VCH Verlag GmbH, 2002, page 88). Soil antiredeposition agents may function by various mechanisms. Regarding soil release agents it is often assumed that these are deposited and accumulated on the fiber surface during laundry washing, thereby modifying the surface properties of the fibers. Soil and dirt that is subsequently deposited onto this modified fiber surface is easier released in a subsequent washing cycle.

The objective of the present invention is to provide an improved method, suitable for the household sector, by means of which soil redeposition can be prevented and soil and dirt can be easier released from textile fibers in laundry processes. A further object is to provide washing formulations suitable for that method.

It has now been found, surprisingly, that the mentioned objectives can be met to a great extent by the use of comb or block copolymers which have been prepared by controlled free radical polymerization and then subjected to a polymer analogous transesterification.

One aspect of the invention is the use of one or more comb or block copolymers as soil antiredeposition agents and soil release agents in aqueous laundry processes where the comb or block copolymers have been prepared in a first step

a) by controlled free radical polymerization of a C₁-C₁₀ alkyl ester of acrylic or methacrylic acid and optionally one or more monomers without an ester bond; and in a second step

b) modified in a polymer analogous transesterification reaction with a primary or secondary alcohol

to form a comb or block copolymer.

It has been found that the controlled free radical polymerisation (CFRP) is a tool to for using them as soil antiredeposition agents or soil release agents during a washing process. The combination of CFRP with subsequent post-modification of the stabilizing block allows enlarging the possible groups that can be used in the above mentioned detergent applications. With one CFRP-process a large row of different polymer materials becomes available. Block and comb copolymers prepared in such a two step reaction are, for example, described in WO 20060074969.

Controlled free radical polymerization using alkoxyamines or stable nitroxyl radicals is a well known technique and has been described extensively in the last twenty years.

For example U.S. Pat. No. 4,581,429 discloses a free radical polymerization process which controls the growth of polymer chains to produce short chain or oligomeric homopolymers and copolymers. The process employs an initiator having the formula (in part) R′R″N—O—X, where X is a free radical species capable of polymerizing unsaturated monomers and the radical R″R″N—O. is terminating the growing oligomer/polymer.

U.S. Pat. No. 5,322,912 discloses a polymerization process using a free radical initiator, a polymerizable monomer compound and a stable free radical agent of the basic structure R′R″N—O. for the synthesis of homopolymers and block copolymers which are terminated by the nitroxyl radical.

More recently further nitroxyl radicals and nitroxyl ethers have been described. WO 98/3392 for example describes open chain alkoxyamine compounds, which have a symmetrical substitution pattern and are derived from NO gas or from nitroso compounds.

WO 9624620 describes a polymerization process in which very specific stable free radical agents are used, such as for example

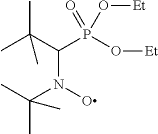

WO 9830601 discloses specific nitroxyls based on imidazolidinons.

WO 9844008 discloses specific nitroxyls based on morpholinones, piperazinones and piperazindiones.

These prior art nitroxyl radicals and nitroxyl ethers are all suitable for the instant invention.

The nitroxylethers and nitroxyl radicals suitable for the invention are principally known from U.S. Pat. No. 4,581,429 or EP-A-621 878. Particularly useful are the open chain compounds described in WO 98/3392, WO 9903894 and WO 0007981, the piperidine derivatives described in WO 9967298, GB 2335190 and GB 2 361 235 or the heterocyclic compounds described in GB 2342649 and WO 9624620. Recently further nitroxyl radicals and nitroxyl ethers have been described in WO 0248205, WO0248109 and WO 02/00831.

Also suitable are the compounds described by Hawker et al, Chem. Commun., 2001, 823-824

Some compounds are commercially available or can be prepared according to the aforementioned documents.

For example, the structural element of the alkoxyamine,

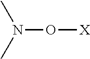

is a structural element of formula (I) and the structural element of the stable nitroxyl radical,

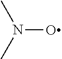

is a structural element of formula (II)

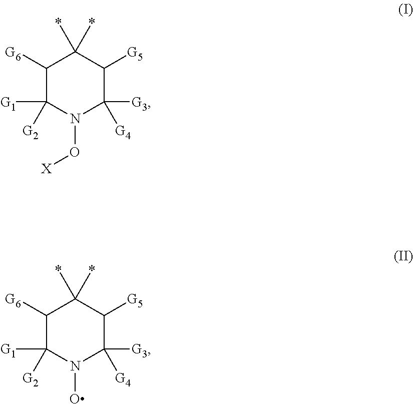

wherein

G₁, G₂, G₃, G₄ are independently C₁-C₆alkyl or G₁ and G₂ or G₃ and G₄, or G₁ and G₂ and G₃ and G₄ together form a C₅-C₁₂cycloalkyl group;

G₅, G₆ independently are H, C₁-C₁₈alkyl, phenyl, naphthyl or a group COOC₁-C₁₈alkyl;

X is selected from the group consisting of —CH₂-phenyl, CH₃CH-phenyl, (CH₃)₂C-phenyl, (C₅-C₆cycloalkyl)₂CCN, (CH₃)₂CCN,

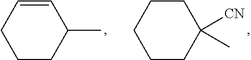

—CH₂CH═CH₂, CH₃CH—CH═CH₂ (C₁-C₄alkyl)CR₂₀—C(O)-phenyl, (C₁-C₄)alkyl-CR₂₀—C(O)—(C₁-C₄)alkoxy, (C₁-C₄)alkyl-CR₂₀—C(O)—(C₁-C₄)alkyl, (C₁-C₄)alkyl-CR₂₀—C(O)—N-di(C₁-C₄)alkyl, (C₁-C₄)alkyl-CR₂₀—C(O)—NH(C₁-C₄)alkyl, (C₁-C₄)alkyl-CR₂₀—C(O)—NH₂, wherein R₂₀ is hydrogen or (C₁-C₄)alkyl and

* denotes a valence.

In a very specific embodiment the alkoxyamine used for the controlled free radical polymerization is a compound of formula NOR01.

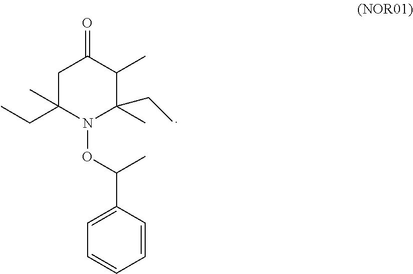 [SMILES: CCC1(C)CC(=O)C(C)C(C)(CC)N1OC(C)c1ccccc1]

Preferably the alkoxyamine compound is used in an amount from 0.01 mol-% to 30 mol-%, more preferably in an amount of from 0.1 mol-% to 20 mol-% and most preferred in an amount of from 0.1 mol-% to 10 mol-% based on the monomer.

Because CFRP is a “living” polymerization, it can be started and stopped practically at will. Furthermore, the polymer product retains the functional alkoxyamine group allowing a continuation of the polymerization in a living matter. Thus, once the first monomer is consumed in the initial polymerizing step a second monomer can then be added to form a second block on the growing polymer chain in a second polymerization step. Therefore it is possible to carry out additional polymerizations with the same or different monomer(s) to prepare multi-block copolymers.

Furthermore, since this is a radical polymerization, blocks can be prepared in essentially any order. One is not necessarily restricted to preparing block copolymers where the sequential polymerizing steps must flow from the least stabilized polymer intermediate to the most stabilized polymer intermediate, such as is the case in ionic polymerization. Thus it is possible to prepare a multi-block copolymer in which a polyacrylonitrile or a poly(meth)acrylate block is prepared first and then a styrene block is attached thereto.

Furthermore, there is no linking group required for joining the different blocks of the present block copolymer. One can simply add successive monomers to form successive blocks. The blocks might be separated by a tapered zone, in which monomers of both the previous and continued block are present in different ratios.

A plurality of specifically designed polymers and copolymers are accessible by, such as star and graft (co)polymers as described, inter alia, by C. J. Hawker in Angew. Chemie, 1995, 107, pages 1623-1627, dendrimers as described by K. Matyaszewski et al. in Macromolecules 1996, Vol 29, No. 12, pages 4167-4171, graft (co)polymers as described by C. J, Hawker et al. in Macromol. Chem. Phys. 198, 155-166(1997), random copolymers as described by C. J. Hawker in Macromolecules 1996, 29, 2686-2688, or diblock and triblock copolymers as described by N. A, Listigovers in Macromolecules 1996, 29, 8992-8993.

For example, the comb or block copolymer has a polydispersity, PD from 1.0 to 2.5, preferably from 1.1 to 2.0.

In a preferred embodiment the comb or block copolymer has amphiphilic properties.

Preferably the comb or block copolymer has been prepared in step a) from n-butylacrylate and optionally from one or more monomers without an ester bond.

For instance, the monomer without an ester bond is selected from the group consisting of 4-vinyl-pyridine, 2-vinyl-pyridine, vinyl-imidazole, vinyl-pyrrolidone, dimethylacrylamide, 3-dimethylaminopropylmethacrylamide, styrene, α-methyl styrene, p-methyl styrene or p-tert-butyl-styrene, acrylonitrile. The aminic monomers may also be used in their ionised or quaterized forms, or be modified afterwards in a consecutive step.

When the controlled free radical polymerization is carried out with a nitroxyl radical an initiating radical source is additionally necessary. This radical source initiator is preferably an azo compound, a peroxide, perester or a hydroperoxide.

Specific preferred radical sources are 2,2′-azobisisobutyronitrile, 2,2′-azobis(2-methylbutyronitrile), 2,2′-azobis(2,4-dimethylvaleronitrile), 2,2′-azobis(4-methoxy-2,4-dimethylvaleronitrile), 1,1′-azobis(1-cyclohexanecarbonitrile), 2,2′-azobis(isobutyramide)dihydrate, 2-phenylazo-2,4-dimethyl-4-methoxyvaleronitrile, dimethyl-2,2′-azobisisobutyrate, 2-(carbamoylazo)isobutyronitrile, 2,2′-azobis(2,4,4-trimethylpentane), 2,2′-azobis(2-methylpropane), 2,2′-azobis(N,N′-dimethyleneisobutyramidine), free base or hydrochloride, 2,2′-azobis(2-amidinopropane), free base or hydrochloride, 2,2′-azobis{2-methyl-N-[1,1-bis(hydroxymethyl)ethyl]propionamide} or 2,2′-azobis{2-methyl-N-[1,1-bis(hydroxymethyl)-2-hydroxyethyl]propionamide; acetyl cyclohexane sulphonyl peroxide, diisopropyl peroxy dicarbonate, t-amyl perneodecanoate, t-butyl perneodecanoate, t-butyl perpivalate, t-amylperpivalate, bis(2,4-dichlorobenzoyl)peroxide, diisononanoyl peroxide, didecanoyl peroxide, dioctanoyl peroxide, dilauroyl peroxide, bis(2-methylbenzoyl) peroxide, disuccinic acid peroxide, diacetyl peroxide, dibenzoyl peroxide, t-butyl per 2-ethylhexanoate, bis-(4-chlorobenzoyl)-peroxide, t-butyl perisobutyrate, t-butyl permaleinate, 1,1-bis(t-butylperoxy)3,5,5-trimethylcyclohexane, 1,1-bis(t-butylperoxy)cyclohexane, t-butyl peroxy isopropyl carbonate, t-butyl perisononaoate, 2,5-dimethylhexane 2,5-dibenzoate, t-butyl peracetate, t-amyl perbenzoate, t-butyl perbenzoate, 2,2-bis(t-butylperoxy) butane, 2,2 bis(t-butylperoxy) propane, dicumyl peroxide, 2,5-dimethylhexane-2,5-di-t-butylperoxide, 3-t-butylperoxy 3-phenylphthalide, di-t-amyl peroxide, α,α′-bis(t-butylperoxy isopropyl)benzene, 3,5-bis(t-butylperoxy)3,5-dimethyl 1,2-dioxolane, di-t-butyl peroxide, 2,5-dimethylhexyne-2,5-di-t-butylperoxide, 3,3,6,6,9,9-hexamethyl 1,2,4,5-tetraoxa cyclononane, p-menthane hydroperoxide, pinane hydroperoxide, diisopropylbenzene mono-α-hydroperoxide, cumene hydroperoxide or t-butyl hydroperoxide.

The radical source is preferably present in an amount of from 0.01 mol-% to 30 mol-%, more preferred in an amount of from 0.1 mol-% to 20 mol-% and most preferred in an amount of from 0.5 mol-% to 10 mol-% based on the monomer.

The molar ratio of the radical source to the nitroxyl radical may be from 1:10 to 10:1, preferably from 1:5 to 5:1 and more preferably from 1:2 to 2:1.

The reaction conditions for the CFRP step a) are widely described in the documents listed above. In general the polymerization temperature is between 60 and 180° C. at normal pressure and the reaction time may vary from 30 minutes to 20 hours.

For example the primary or secondary alcohol in the transesterification of step b) is an ethoxylate of formula (A) R_{A}-[O—CH₂—CH₂—]ₙ—OH (A) wherein R_{A} is saturated or unsaturated, linear or branched chain alkyl with 1-22 carbon atoms, or alkylaryl or dialkylaryl with up to 24 carbon atoms and n is 1 to 150;

a polydimethylsilicone oligomer of formula (B)

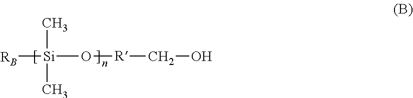

wherein R_{B} is C₁-C₁₈alkyl, phenyl or C₇-C₁₅aralkyl; n is 1 to 50 and R′ is a linking group with 1 to 20 carbon atoms;

a partly or fully fluorinated primary alcohol;

a C₈ to C₆₀alkyl linear or branched primary or secondary alcohol;

a racemic mixture of 2,2-dimethyl-4-hydroxymethyl-1,3-dioxolane;

a primary or secondary alcohol containing at least one a tertiary amine group such as N,N,N′-Trimethylaminoethylethanolamin, 4-hydroxyethyl-pyridine and N-hydroxyethylmorpholine or

a primary alcohol whose chain is interrupted by at least one ester group such as polycaprolactone α-cetyloxy, -ω-hydroxy with a molecular weight from 750 to 2500 g/mol.

In the term alkylaryl, aryl means phenyl or naphthyl and alkyl is preferably C₁-C₂₀ linear or branched alkyl.

In a specific embodiment the alcohol is a partly or fully fluorinated primary alcohol. Examples of commercial fluorinated alcohol mixtures are: Zonyl BA®, Zonyl BA-L®, Zonyl BA-LD®, Zonyl BA-N® from Du Pont Pont or fluorinated polyoxetane alcohols from Omnova Solutions Inc.

Preferably the primary alcohol of step b) is an ethoxylate of formula (A): R_{A}-[O—CH₂—CH₂-]ₙ—OH (A) wherein R_{A} is saturated or unsaturated, linear or branched chain alkyl with 1-22 carbon atoms and n is 1 to 150;

a racemic mixture of 2,2-dimethyl-4-hydroxymethyl-1,3-dioxolane;

N,N,N′-trimethylaminoethylethanolamin;

N-hydroxyethylmorpholine; or

polycaprolactone α-cetyloxy, -ω-hydroxy with a molecular weight from 750 to 2500 Oral.

Typically the aqueous laundry process is a domestic laundry process.

For example the textile is made from polyester, polyacryl, cotton, wool, polyamide or mixtures thereof, preferably it is cotton.

Another aspect of the invention is a method for preventing soil redeposition on textiles and for soil release from textiles during an aqueous laundry process, which method comprises applying a comb or block copolymer which has been prepared in a first step

a) by controlled free radical polymerization of a C₁-C₁₀ alkyl ester of acrylic or methacrylic acid and optionally one or more monomers without an ester bond; and in a second step;

b) modified in a polymer analogous transesterification reaction with a primary or secondary alcohol;

to form a comb or block copolymer.

When the comb or block copolymer is used as part of a detergent it may be present in an amount of from 0.05 to 20% by weight based on the weight of the total detergent composition.

Also aspects of the invention are detergent compositions comprising:
I) from 1 to 50 wt-%, based on the total weight of the composition, A) of at least one surfactant;
II) from 0 to 70 wt-%, based on the total weight of the composition. B) of at least one builder substance;
III) from 0-30 wt-%, based on the total weight of the composition. C) of at least one peroxide and/or one peroxide-forming substance;
IV) from 0.05 to 10 wt.-%, preferably 0.05 to 5 wt %, more preferably 0.1 to 4 wt % based on the total weight of the composition. D) of at least one comb or block copolymer as defined above;
V) from 0-60 wt-%, based on the total weight of the composition, E) of at least one further additive;
VI) from 0-90 wt %, based on the total weight of the composition, F) water.

The composition according to the invention can be, for example, a solid peroxide-containing heavy-duty detergent, a detergent powder for delicate textiles, a laundry detergent powder for colored goods, or a structured (i.e. turbid) or unstructured (i.e. clear) water based liquid detergent.

Surfactants of Component A)

The detergent formulation will normally include at least one surfactant which may be anionic, cationic, nonionic or amphoteric.

The anionic surfactant can be, for example, a sulfate, sulfonate or carboxylate surfactant or a mixture thereof. Preference is given to alkylbenzenesulfonates, alkyl sulfates, alkyl ether sulfates, olefin sulfonates, fatty acid salts, alkyl and alkenyl ether carboxylates or to an α-sulfonic fatty acid salt or an ester thereof.

Preferred sulfonates are, for example, alkylbenzenesulfonates having from 10 to 20 carbon atoms in the alkyl radical, alkyl sulfates having from 8 to 18 carbon atoms in the alkyl radical, alkyl ether sulfates having from 8 to 18 carbon atoms in the alkyl radical, and fatty acid salts derived from palm oil or tallow and having from 8 to 18 carbon atoms in the alkyl moiety. The average molar number of ethylene oxide units added to the alkyl ether sulfates is from 1 to 20, preferably from 1 to 10. The cation in the anionic surfactants is preferably an alkaline metal cation, especially sodium or potassium, more especially sodium. Preferred carboxylates are alkali metal sarcosinates of formula R₁₉—CON(R_{20′})CH₂COOM₁ wherein R_{19′} is C₉-C₁₇alkyl or C₉-C₁₇alkenyl, R_{20′} is C₁-C₄alkyl and M₁ is an alkali metal, especially sodium.

The non-ionic surfactant may be, for example, a primary or secondary alcohol ethoxylate, especially a C₈-C₂₀ aliphatic alcohol ethoxylated with an average of from 1 to 20 mol of ethylene oxide per alcohol group. Preference is given to primary and secondary C₁₀-C₁₅ aliphatic alcohols ethoxylated with an average of from 1 to 10 mol of ethylene oxide per alcohol group. Non-ethoxylated non-ionic surfactants, for example alkylpolyglycosides, glycerol monoethers and polyhydroxyamides (glucamide), may likewise be used.

In addition to anionic and/or non-ionic surfactants the composition may contain cationic surfactants. Possible cationic surfactants include all common cationic surface-active compounds, especially surfactants having a textile softening effect.

Non-limited examples of cationic surfactants are given in the formulas below:

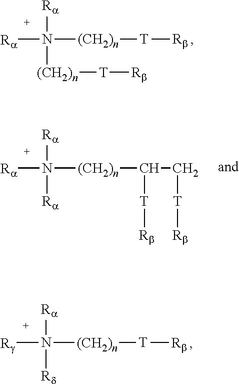

wherein

each radical R_{α} is independent of the others C₁₋₆-alkyl-, -alkenyl- or -hydroxyalkyl; each radical R_{β} is independent of the others C₈₋₂₈-alkyl- or alkenyl;

R_{γ} is R_{β} or (CH₂)ₙ-T-R_{β};

R_{δ} is R_{α} or R_{β} (CH₂)ₙ-T-R_{β}; T=—CH₂—, —O—CO— or —CO—O— and

n is between 0 and 5.

Preferred cationic surfactants present in the composition according to the invention include hydroxyalkyl-trialkyl-ammonium-compounds, especially C₁₂₋₁₈alkyl(hydroxyethyl)dimethylammonium compounds, and especially preferred the corresponding chloride salts.

Compositions of the present invention can contain between 0.5 wt-% and 15 wt-% of the cationic surfactant, based on the total weight of the composition.

The total amount of surfactants is preferably from 1 to 50 wt-%, especially from 1 to 40 wt-% and more especially from 1 to 30 wt-%.

Builder Substance B)

As builder substance B) there come into consideration, for example, alkali metal phosphates, especially tripolyphosphates, carbonates and hydrogen carbonates, especially their sodium salts, silicates, aluminum silicates, polycarboxylates, polycarboxylic acids, organic phosphonates, aminoalkylenepoly(alkylenephosphonates) and mixtures of such compounds.

Silicates that are especially suitable are sodium salts of crystalline layered silicates of the formula NaHSiₜO₂ₜ₊₁.pH₂ or Na₂SiₜO₂ₜ₊₁.pH₂O wherein t is a number from 1.9 to 4 and p is a number from 0 to 20.

Among the aluminum silicates, preference is given to those commercially available under the names zeolite A, B, X and HS, and also to mixtures comprising two or more of such components. Special preference is given to zeolite A.

Among the polycarboxylates, preference is given to polyhydroxycarboxylates, especially citrates, and acrylates, and also to copolymers thereof with maleic anhydride. Preferred polycarboxylic acids are nitrilotriacetic acid, ethylenediaminetetraacetic acid and ethylenediamine disuccinate either in racemic form or in the enantiomerically pure (S,S) form.

Phosphonates or aminoalkylenepoly(alkylenephosphonates) that are especially suitable are alkali metal salts of 1-hydroxyethane-1,1-diphosphonic acid, nitrilotris(methylenephosphonic acid), ethylenediaminetetramethylenephosphonic acid and diethylenetriaminepentamethylenephosphonic acid, and also salts thereof. Also preferred polyphosphonates have the following formula

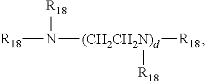

wherein

R₁₈ is CH₂PO₃H₂ or a water soluble salt thereof and

d is an integer of the value 0, 1, 2 or 3.

Especially preferred are the polyphosphonates wherein b is an integer of the value of 1

Peroxide Component C)

As the peroxide component C) there come into consideration every compound which is capable of yielding hydrogen peroxide in aqueous solutions, for example, the organic and inorganic peroxides known in the literature and available commercially that bleach textile materials at conventional washing temperatures, for example at from 10 to 95° C. Preferably, however, inorganic peroxides are used, for example persulfates, perborates, percarbonates and/or persilicates.

All these peroxy compounds may be utilized alone or in conjunction with a peroxyacid bleach precursor and/or a bleach catalyst. Peroxy acids precursers are often referred to as bleach activators. Suitable bleach activators include the bleach activators, that carry O- and/or N-acyl groups and/or unsubstituted or substituted benzoyl groups. Preference is given to polyacylated alkylenediamines, especially tetraacetylethylenediamine (TAED); acylated glycolurils, especially tetraacetyl glycol urea (TAGU), N,N-diacetyl-N,N-dimethylurea (DDU); sodium-4-benzoyloxy benzene sulphonate (SBOBS); sodium-1-methyl-2-benzoyloxy benzene-4-sulphonate; sodium-4-methyl-3-benzoloxy benzoate; trimethyl ammonium toluyloxy-benzene sulphonate; acylated triazine derivatives, especially 1,5-diacetyl-2,4-dioxohexahydro-1,3,5-triazine (DADHT); compounds of formula (6):

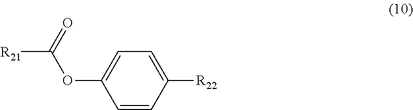

wherein R₂₂ is a sulfonate group, a carboxylic acid group or a carboxylate group, and wherein R₂₁ is linear or branched (C₇-C₁₅)alkyl, especially activators known under the names SNOBS, SLOBS and DOBA; nitrile compounds that form perimine acids with peroxides also come into consideration as bleach activators. These bleach activators may be used in an amount of up to 12 wt-%, preferably from 2-10 wt-% based on the total weight of the composition.

It is also possible to use further bleach catalysts, which are commonly known, for example transition metal complexes as disclosed in EP 1194514, EP 1383857 or WO04007657.

Further bleach catalysts are disclosed in: US 2001044401, EP 0458397, WO 9606154, EP 1038946, EP 0900264, EP 0909809, EP 1001009, WO 9965905, WO 0248301, WO 0060045, WO 02077145, WO 0185717, WO 0164826, EP 0923635, DE 19639603, DE102007017654, DE102007017657, DE102007017656, US 20030060388, EP 0918840B1, EP 1174491A2, EP 0805794B1, WO 9707192A1, U.S. Pat. No. 6,235,695B1, EP 0912690B1, EP 832969B1, U.S. Pat. No. 6,479,450B1, WO 9933947A1, WO 0032731A1, WO 03054128A1, DE102004003710, EP 1083730, EP 1148117, EP 1445305, U.S. Pat. No. 6,476,996, EP 0877078, EP 0869171, EP 0783035, EP 0761809 and EP 1520910.

The compositions may comprise, in addition to the combination according to the invention, one or more optical brighteners, for example from the classes bis-triazinylaminostilbenedisulfonic acid, bis-triazolyl-stilbenedisulfonic acid, bis-styryl-biphenyl or bisbenzofuranylbiphenyl, a bis-benzoxalyl derivative, bis-benzimidazolyl derivative or coumarin derivative or a pyrazoline derivative.

The compositions may furthermore comprise one or more further additives. Such additives are, for example, dirt-suspending agents, for example sodium carboxymethylcellulose; pH regulators, for example alkali metal or alkaline earth metal silicates; foam regulators, for example soap; salts for adjusting the spray drying and the granulating properties, for example sodium sulfate; perfumes; and also, if appropriate, antistatics and softening agents such as, for example, smectite; bleaching agents; pigments; and/or toning agents. These constituents should especially be stable to any bleaching agent employed.

If such auxiliaries are used they are added in a total amount of from 0.1-20 wt-%, preferably from 0.5-10 wt-%, especially from 0.5-5 wt-%, based on the total weight of the detergent formulation.

Furthermore, the detergent may optionally also comprise enzymes. Enzymes can be added for the purpose of stain removal. The enzymes usually improve the action on stains caused by protein or starch, such as, for example, blood, milk, grass or fruit juices. Preferred enzymes are cellulases and proteases, especially proteases. Cellulases are enzymes that react with cellulose and its derivatives and hydrolyse them to form glucose, cellobiose and cellooligosaccharides. Cellulases remove dirt and, in addition, have the effect of enhancing the soft handle of the fabric.

Examples of customary enzymes include, but are by no means limited to, the following:

proteases as described in U.S. Pat. No. 6,242,405, column 14, lines 21 to 32;

lipases as described in U.S. Pat. No. 6,242,405, column 14, lines 33 to 46;

amylases as described in U.S. Pat. No. 6,242,405, column 14, lines 47 to 56; and

cellulases as described in U.S. Pat. No. 6,242,405, column 14, lines 57 to 64;

Commercially available detergent proteases, such as Alcalase®, Esperase®, Everlase®, Savinase®, Kannase® and Durazym®, sold e.g. by NOVOZYMES NS;

Commercially available detergent amylases, such as Termamyl®, Duramyl®, Stainzyme®, Natalase®, Ban® and Fungamyl®, sold e.g. by NOVOZYMES AS; Commercially available detergent ellulases, such as Celluzyme®, Carezyme® and Endolase®, sold e.g. by NOVOZYMES NS;

Commercially available detergent lipases, such as Lipolase®, Lipolase Ultra® and Lipoprime®, sold e.g. by NOVOZYMES A/S;

Suitable mannanases, such as Mannanaway®, sold by NOVOZYMES A/S.

The enzymes, when used, may be present in a total amount of from 0.01 to 5 wt-%, especially from 0.05 to 5 wt-% and more especially from 0.1 to 4 wt-%, based on the total weight of the detergent formulation.

Further preferred additives to the compositions according to the invention are dye-fixing agents and/or polymers which, during the washing of textiles, prevent staining caused by dyes in the washing liquor that have been released from the textiles under the washing conditions. Such polymers are preferably polyvinylpyrrolidones, polyvinylimidazoles or polyvinylpyridine-N-oxides, which may have been modified by the incorporation of anionic or cationic substituents, especially those having a molecular weight in the range of from 5000 to 60 000, more especially from 10 000 to 50 000. If such polymers are used, they are usually used in a total amount of from 0.01 to 5 wt-%, especially from 0.05 to 5 wt-%, more especially from 0.1 to 2 wt-%, based on the total weight of the detergent formulation. Preferred polymers are those mentioned in WO-A-0202865 (see especially page 1, last paragraph and page 2, first paragraph) and those in WO-A-0405688.

The compositions of the invention herein may also optionally contain one or more heavy metal chelating agents, such as hydroxyethyldiphosphonate (HEDP). More generally, chelating agents suitable for use herein can be selected from the group consisting of amino carboxylates, amino phosphonates, polyfunctionally-substituted aromatic chelating agents and mixtures thereof. Other suitable chelating agents for use herein are the commercial DEQUEST series, and chelants from Nalco, Inc.

Aminocarboxylates useful as optional chelating agents include ethylenediaminetetracetates, N-hydroxyethylethylenediaminetriacetates, nitrilotriacetates, ethylenediamine tetraproprionates, triethylenetetraaminehexacetates, diethylenetriamine-pentaacetates, and ethanoldiglycines, alkali metal, ammonium, and substituted ammonium salts thereof and mixtures thereof.

Aminophosphonates are also suitable for use as chelating agents in the compositions of the invention when at least low levels of total phosphorus are permitted in detergent compositions, and include ethylenediaminetetrakis (methylenephosphonates).

Further biodegradable sequestrants are, for example, aminoacid acetates, such as Trilon M (BASF) and Dissolvine GL (AKZO), as well as asparaginic acid derivatives, such as Baypure CX.

Preferably, the aminophosphonates do not contain alkyl or alkenyl groups with more than about 6 carbon atoms.

A highly preferred biodegradable chelator for use herein is ethylenediamine disuccinate

If utilized, these chelating agents or transition-metal selective sequestrants will generally comprise from about 0.001 wt-96 to about 10 wt-%, more preferably from about 0.05 wt-% to about 1 wt-% of the laundry detergent compositions herein,

Preferred compositions herein may additionally contain a dispersant polymer. When present, a dispersant polymer is typically at levels in the range from 0 wt-% to about 25 wt-%, preferably from about 0.5 wt-% to about 20 wt-%, more preferably from about 1 wt-% to about 8 wt-% of the detergent composition.

Suitable polymers are preferably at least partially neutralized or alkali metal, ammonium or substituted ammonium (e.g., mono-, di- or triethanolammonium) salts of polycarboxylic acids. The alkali metal, especially sodium salts are most preferred. While the molecular weight of the polymer can vary over a wide range, it preferably is from about 1,000 to about 500,000, more preferably is from about 1,000 to about 250,000.

Unsaturated monomeric acids that can be polymerized to form suitable dispersant polymers include acrylic acid, maleic acid (or maleic anhydride), fumaric acid, itaconic acid, aconitic acid, mesaconic acid, citraconic acid and methylenemalonic acid. The presence of monomeric segments containing no carboxylate radicals such as methyl vinyl ether, styrene, ethylene, etc. is suitable provided that such segments do not constitute more than about 50 wt-% of the dispersant polymer.

Copolymers of acrylamide and acrylate having a molecular weight of from about 3,000 to about 100,000, preferably from about 4,000 to about 20,000, and an acrylamide content of less than about 50 wt-%, preferably less than about 20 wt-% of the dispersant polymer can also be used. Most preferably, such dispersant polymer has a molecular weight of from about 4,000 to about 20,000 and an acrylamide content of from about 0 wt-% to about 15 wt-%, based on the total weight of the polymer.

Particularly preferred dispersant polymers are low molecular weight modified polyacrylate copolymers. Such copolymers contain as monomer units: a) from about 90 wt-% to about 10 wt-%, preferably from about 80 wt-% to about 20 wt-% acrylic acid or its salts and b) from about 10 wt-% to about 90 wt-%, preferably from about 20 wt-% to about 80 wt-% of a substituted acrylic monomer or its salt and have the general formula: —[(C(R_{a′})C(R_{b})(C(O)OR_{c′})] wherein the apparently unfilled valencies are in fact occupied by hydrogen and at least one of the substituents R_{a′}, R_{b′}, or R_{c′}, preferably R_{a′} or R_{b′}, is a 1 to 4 carbon alkyl or hydroxyalkyl group; R_{a′} or R_{b′} can be a hydrogen and Rₑ can be a hydrogen or alkali metal salt. Most preferred is a substituted acrylic monomer wherein R_{a′} is methyl, R_{b′} is hydrogen, and R_{c′} is sodium.

A suitable low molecular weight polyacrylate dispersant polymer preferably has a molecular weight of less than about 15,000, preferably from about 500 to about 10,000, most preferably from about 1,000 to about 5,000. The most preferred polyacrylate copolymer for use herein has a molecular weight of about 3,500 and is the fully neutralized form of the polymer comprising about 70 wt-% acrylic acid and about 30 wt-% methacrylic acid.

Other dispersant polymers useful herein include the polyethylene glycols and polypropylene glycols having a molecular weight of from about 950 to about 30,000.

Yet other dispersant polymers useful herein include the cellulose sulfate esters such as cellulose acetate sulfate, cellulose sulfate, hydroxyethyl cellulose sulfate, methylcellulose sulfate, and hydroxypropylcellulose sulfate. Sodium cellulose sulfate is the most preferred polymer of this group.

Other suitable dispersant polymers are the carboxylated polysaccharides, particularly starches, celluloses and alginates.

Yet another group of acceptable dispersants are the organic dispersant polymers, such as polyaspartate.

Organic solvents that can be used in the cleaning formulations according to the invention, especially when the latter are in liquid or paste form, include alcohols having from 1 to 4 carbon atoms, especially methanol, ethanol, isopropanol and tert-butanol, diols having from 2 to 4 carbon atoms, especially ethylene glycol and propylene glycol, and mixtures thereof, and the ethers derivable from the mentioned classes of compound. Such water-miscible solvents are present in the cleaning formulations according to the invention preferably in amounts not exceeding 20 wt-%, especially in amounts of from 1 wt-% to 15 wt-%.

The detergent formulations can take a variety of physical forms such as, for example, powder granules, tablets (tabs), gel and liquid. Examples thereof include, inter alia, conventional high-performance detergent powders, supercompact high-performance detergent powders, conventional heavy duty liquid detergents, highly concentrated gels and tabs.

The detergent formulation may also be in the form of an aqueous liquid containing from 5 wt-% to 90 wt-%, preferably from 10 wt-% to 70 wt-%, of water or in the form of a non-aqueous liquid containing no more than 5 wt-%, preferably from 0 wt-% to 1 wt-% of water. Non-aqueous liquid detergent formulations may comprise other solvents as carriers. Low molecular weight primary or secondary alcohols, for example methanol, ethanol, propanol and isopropanol, are suitable for that purpose. The solubilising surfactant used is preferably a monohydroxy alcohol but polyols, such as those containing from 2 to 6 carbon atoms and from 2 to 6 hydroxy groups (e.g., 1,3-propanediol, ethylene glycol, glycerol and 1,2-propanediol) can also be used. Such carriers are usually used in a total amount of from 5 wt-% to 90 wt-%, preferably from 10 wt-% to 50 wt-%, based on the total weight of the detergent formulation. The detergent formulations can also used in so-called “unit liquid dose” form.

The definitions and preferences given above apply equally for all aspects of the invention.

The following examples illustrate the invention,

### Abbreviations and Reagents

GPC: gel permeation chromatography

PS-Standard: polystyrene standards for GPC calibration

mbara=millibar absolute pressure

SC=solid content measurement by Halogen dryer Mettler Toledo (at 150° C., 0.5 g sample). (The result is obtained as weight %).

THF: tetrahydrofurane

EtOH: ethanol

MeOH: methanol

TFAA: trifluoroacetic anhydride

PTSA: para-toluenesulfonic acid monohydrate

MPA: 1-methoxy-2-propyl acetate

n-BA: n-butylacrylate

PD: polydispersity (the polydispersity of a sample is defined as weight average molecular weight Mw divided by Mn and gives an indication how narrow a distribution is) 4VP: 4-vinylpyridine, obtainable from the company Schenectady International Cetylalcohol (98% purel-hexadecanol, obtainable from the company Cognis) LIAL® 125 A: mixture of straight chain and mono-branched C₁₂₋₁₅alkanols from Sasol Olefins and Surfactants GmbH.

LuN400: Lupragen® N 400: N,N′,N″-trimethylaminoethylethanolamine, obtainable from the company BASF

PCL1075: polycaprolactone alpha-cetyloxy-, omega-hydroxy-, with Mn of 1075 g/mol.

LuON70: Lutensol® ON 70 (polyethylene glycol mono-isodecylether with Mn of 466 g/mol, obtainable from the company BASF)

MPEG500 (poly ethylene glycol monomethylether with Mn of 500 g/mol, obtainable from the company Clariant)

Solketal: racemic mixture of isopropylidene group protected glycerol, (+/−)-2,2-Dimethyl-4-hydroxymethyl-1,3-dioxolane

HEMO: N-Hydroxyethylmorpholine

LitOBu: Lithium-tertbutoxylate obtainable from Aldrich Inc

DOWEX 50WX8 is an acid ion exchange resin obtainable from the company DOW. To activate Dowex, it was soaked overnight in 2% HCl solution, then filtered, washed with water and dried in an oven at 80° C.

NOR 01: polymerization regulator, which is prepared according to GB 2335190.

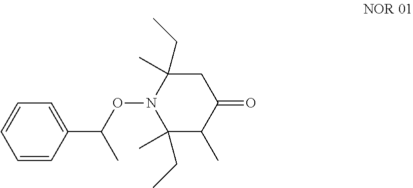 [SMILES: CCC1(C)CC(=O)C(C)C(C)(CC)N1OC(C)c1ccccc1]

General idealized structure of comb-copolymers based on controlled free radical polymerization of nBA, obtained by transesterification:

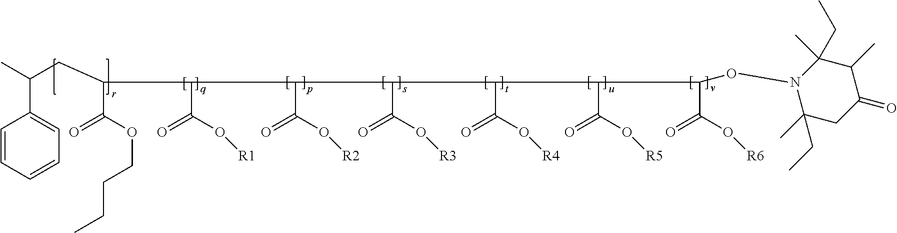

The transesterification proceeds at random. This is not reflected properly by many formulae, according to which it would seem that there is a block of butyl esters and a block of other esters (R1 to R6). The general formula above means that esters are present at random and the indices show the approximated molar amounts of the respective esters. It should, however, be noted that the abbreviated names e.g. poly(n-BA-co-MPEG500A) of Example A1 do not mention the end groups on both sides of the polymer, i.e. the 1-phenyl-ethyl group and the NOR fragment as shown in the general formula above. The designation -co- in the abbreviated names indicates that the monomers formally constituting the polymer, in this example n-BA and MPEG500-acrylate, are present at random.

The designation -b- as shown in example B3, poly(nBA-b-4VP), means that the polymer consists of two defined blocks, the first of n-BA monomer units and the second block of 4-vinylpyridine monomer units.

LCST-Type Solution Behavior

If the obtained polymers are soluble in water, they might show an LCST-type solution behavior (LCST=lower critical solution temperature), i.e. the solubility of the polymer decreases with increasing temperature). For example a 1 wt % solution of the final polymer in demineralized water is a clear solution at room temperature, but becomes turbid at elevated temperatures above e.g. 50° C. (=LOST). In analogy, this observation can be made in a salt solution (e.g. 1% NaCl in water) and typically for the obtained polymers, the LCST in salt solution might be lower than in demineralized water. Polymers with an LOST below RT are obtained as an emulsion in water, those polymers with an LOST above 85° C. remain a clear solution throughout the measurement and do not show an LOST in the range of interest (RT to 90° C.) for washing applications. An indication of >85° C. means that an LCST is not observed until the maximum measurement temperature of 85° C., which means the solution keeps clear until 85° C.

### A) Preparation of Polymers and Copolymers

### Example B1

### Synthesis of a Linear Polymer Poly(n-BA)

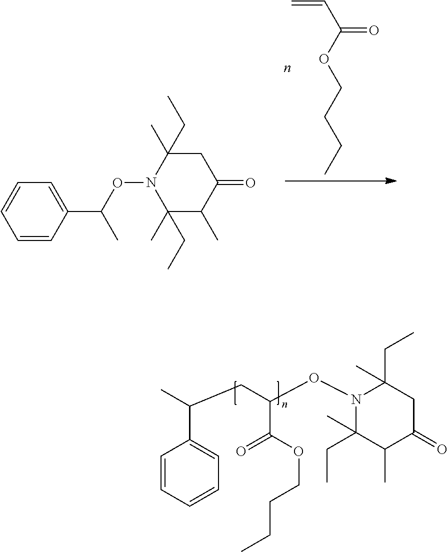

In a 3-necked 1000 ml round bottom flask with magnetic stirring bar, cooler, thermometer, dropping funnel 150.10 g n-butylacrylate (n-BA, 128.2 g/mol), 8.55 g NOR 01 (317.5 g/mol) and 122.13 g of MPA are added, three times degassed with N₂/vacuum and polymerized at 135° C. under N₂ until a conversion of around 8 mol % is reached. 338.89 g of n-BA is slowly added to the reaction with a dropping funnel and polymerized at 135° C. under N₂ until a conversion of around 48 mol % is reached (by SC measurement). Residual monomers and solvents are distilled off at 80° C. and 12 mbara.

A total of 291.29 g of a light yellowish liquid polymer is obtained. GPC (THF, PS-Standard, Mn=7800 g/mol, PD=1.27). According to analysis via ¹H-NMR, the degree of polymerization is 78.

### Example A1

### Poly(n-BA-co-MPEG500A)

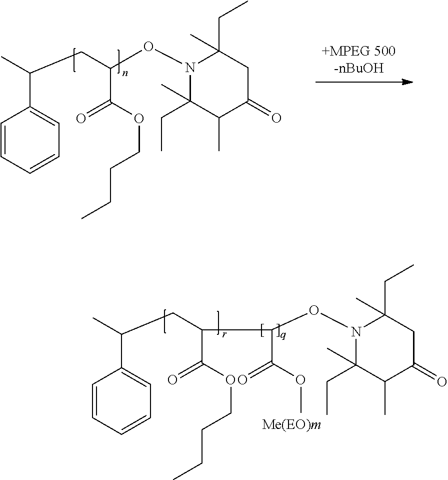

Transesterification Using MPEG500

In a 100 mL flask equipped with an overhead propeller stirrer, distillation column with dry ice acetone cooling 37.0 g of poly(n-BA) according to example B1 and 17.89 g of MPEG500 (Mn=500 g/mol, 10 mol % based on original amount of n-butylesters) are added and dried by degasing at 60° C. for 60 min at 60 mbara. The clear reaction mass in the flask is heated to 135° C. Two portions of 93 mg of LiOtBu are added during 4.5 h at 130-135° C. The formed n-butanol (ca. 2.50 g) is distilled off at reduced pressure (100 mbara).

50.10 g of poly(n-BA-co-MPEG500A) A1 are obtained as a brownish viscous liquid. Mn=12900 g/mol, PD=1.4. Analysis via GPC as well as 1H-NMR indicate almost quantitative conversion of the polyglycol. SC=98.0%.

The polymer A1 emulsified at room temperature as 1 wt % solution in water. The same behavior is observed in a NaCl solution, with the difference that at 50° C. the polymer precipitated.

### Examples A2 to A6

In analogous way as described for polymer A1, the polymers A2 to A6 are prepared with the molar ratios indicated in Table 1.

TABLE 1
preparation of comb copolymers containing MPEG500 side chains

| | | | | | | 1 wt % Solubility |
|---|---|---|---|---|---|---|
| | | | | | LCST | at RT |
| | | | | | 1) in H₂O | 1) in H₂O |
| Example | r | q | Mn g/mol | PD | 2) in 1% NaCl | 2) 1% NaCl |
| A1 | 68 | 10 | 12.900 | 1.40 | <RT | emulsion |
| | | | | | <RT | emulsion |
| A2 | 58 | 20 | 14.080 | 1.38 | >85° C. | clear |
| | | | | | 55° C. | clear |
| A3 | 48 | 30 | 14.780 | 1.36 | >85° C. | clear |
| | | | | | 60° C. | clear |
| A4 | 38 | 40 | 11.760 | 1.50 | >85° C. | clear |
| | | | | | >85° C. | clear |
| A5 | 28 | 50 | 10.390 | 1.46 | 85° C. | clear |
| | | | | | 80° C. | clear |
| A6 | 18 | 60 | 9.590 | 1.34 | >85° C. | clear |
| | | | | | 85° C. | clear |

WO: r (mol units n-butylesters), q (mol units R1) MPEG 500

The resulting polymers also form clear 5 wt % solutions in following organic solvents: butyl acetate, MPA, methoxypropanol, butylglycol and xylene.

### Example A7

### Poly(n-BA-co-MPEG500A-co-LuON70A)

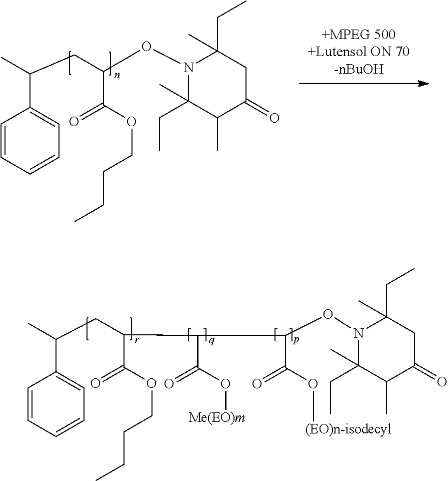

Co-Transesterification Using MPEG500 and Lutensol® ON 70 (Ethoxylated Iso-C10 Alcohol)

In a 100 mL flask equipped with an overhead propeller stirrer, distillation column with dry ice acetone cooling 25.0 g of poly(n-BA) according to example B1, 24.17 g of MPEG500 (Mn=500 g/mol, 20 mol % based on original amount of n-butylesters) and 11.26 g of Lutensol® ON 70 (Mn ca. 466 g/mol, 10 mol % based on original amount of n-butylesters) are added and dried by degasing at 60° C. for 60 min at 60 mbara. The clear reaction mass in the flask is heated to 135° C. Four portions of 108 mg of LiOtBu are added during 6 h at 130-135° C. The formed n-butanol (ca. 5.3 g) is distilled off at reduced pressure (50 mbara).

52.46 g of poly(n-BA-co-MPEG500A-co-LuON70A) A7 are obtained as a brownish viscous Mn=14330 g/mol, PD=1.6. Analysis via GPC as well as 1H-NMR indicate almost quantitative conversion of the glycol ethers. SC=98.0%,

The polymer A7 is a clear solution at room temperature as 1 wt % solution in water. In a 1% NaCl solution an LOST at 85° C. is observed.

### Examples A8 to A11

In analogous way as described for polymer A7, the polymers A8 to A11 containing Lutensol® ON 70 were prepared with the molar ratios indicated in Table 2.

TABLE 2
preparation of comb copolymers containing Lutensol ON 70 side chains

| | | | | | | | 1 wt % |
|---|---|---|---|---|---|---|---|
| | | | | | | LCST | Solubility RT |
| | | | | | | 1) in H₂O | 1) in H₂O |
| Ex. | r | q | p | Mn g/mol | PD | 2) in 1% NaCl | 2) in 1% NaCl |
| A7 | 48 | 20 | 10 | 14.330 | 1.56 | >85° C. | clear |
| | | | | | | 85° C. | clear |
| A8 | 38 | 20 | 20 | 15.200 | 1.49 | >85° C. | clear |
| | | | | | | 65° C. | clear |
| A9 | 28 | 20 | 30 | 16.370 | 1.39 | >85° C. | clear |
| | | | | | | <RT | emulsion |
| A10 | 48 | 0 | 30 | 16.400 | 1.60 | <RT | emulsion |
| | | | | | | n.a. | not soluble |
| A11 | 18 | 0 | 60 | 17.100 | 1.69 | <RT | emulsion |
| | | | | | | n.a. | not soluble |

Legend: r (mol units n-butylesters), q (mol units R1)MPEG 500, p (mol units R2) Lutensol ® ON 70

### Example B2

### Synthesis of PCL1075 Monool

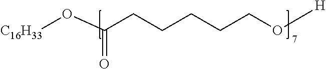

In a 500 mL flask equipped with an overhead propeller stirrer, 493 g of cetylalcohol (MW=242.5 g/mol, 1 mol equivalent) and 171.3 g of epsilon-caprolactone (MW=114, 7.3 mol equivalents) are placed and heated to 170° C. under a dry nitrogen atmosphere. Two drops (ca. 100 mg) of dibutyltindilaurate catalyst are added at 170° C., and the contents subsequently stirred for 8 hours, until a SC of >98 wt % is reached. The resulting colorless polyester is cooled to 80° C. and filled in a glass jar, where it solidifies to 219 g of a waxy white solid.

1H-NMR shows a full conversion of the polycaprolactone monool, and a OH-number is determined at 52.02 mgKOH/g, a SC of 98.57% and a Gardner color <1.

### Example A12

### Poly(n-BA-co-MPEG500A-co-PCL1075A)

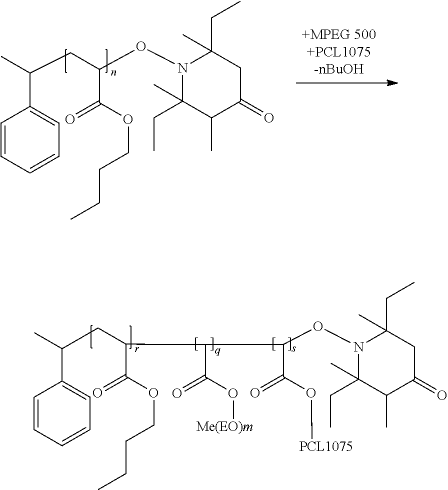

Co-Transesterification Using MPEG500 and PCL1075

In a 100 mL flask equipped with an overhead propeller stirrer, distillation column with dry ice acetone cooling 20.0 g of poly(n-BA) according to example B1, 19.34 g of MPEG500 (Mn=500 g/mol, 20 mol % based on original amount of n-butylesters) and 20.11 g of PCL1075 (example B2) (Mn ca. 1075 g/mol, 10 mol % based on original amount of n-butylesters) are added and dried by degasing at 60° C. for 60 min at 60 mbara. The clear reaction mass in the flask is heated to 135° C. Four portions of 100 mg of LiOtBu are added during 6 h at 130-135° C. The formed n-butanol (ca. 4.3 g) is distilled off at reduced pressure (50 mbara).

52.31 g of poly(n-BA-co-MPEG500A-co-PCL1075A) A12 are obtained as a brownish viscous liquid. Mn=22560 g/mol, PD=1.69. Analysis via GPC as well as 1H-NMR indicate >95% conversion of the MPEG500 and polyesterol. SC=98.3%

The polymer A12 forms an emulsion in both water and 1% NaCl solution, of which the latter it precipitates at 60° C.

### Example A13

### Poly(n-BA-co-MPEG500A-co-PCL1075A)

Consecutive Transesterification Using MPEG500 and PCL1075

In a 100 mL flask equipped with an overhead propeller stirrer, distillation column with dry ice acetone cooling 20.0 g of poly(n-BA) according to example B1 and 19.34 g of MPEG500 (Mn=500 g/mol, 20 mol % based on original amount of n-butylesters) are added and dried by degasing at 60° C. for 60 min at 60 mbara. The clear reaction mass in the flask is heated to 135° C. Three portions of 93 mg of LiOtBu are added during 5.5 h at 130-135° C. After completion of conversion (no n-butanol formation) 20.11 g of PCL1075 (example B2) (Mn ca. 1075 g/mol, 10 mol % based on original amount of n-butylesters) are added to the reaction mass and transesterification is continued at 135° C. for another 4 hours with addition of three portions of 93 mg of LiOtBu. The total amount of formed n-butanol (ca. 4.3 g) is distilled off at reduced pressure (50 mbara). 51.39 g of poly(n-BA-co-MPEG500A-co-PCL1075A) A13 are obtained as a brownish viscous liquid. Mn=22690 g/mol, PD=1.78. Analysis via GPC as well as 1H-NMR indicate >95% conversion of the MPEG500 and polyesterol. SC=98.4%.

The polymer A13 forms a translucent emulsion in water at RT, which becomes turbid at 65° C., while in 1% NaCl solution, at RT an emulsion is formed and the polymer precipitates at 60° C.

### Examples A14 to A15

In analogous way as described for polymer A13, the polymers A14 to A15 and A 25 containing PCL1075 are prepared with the molar ratios indicated in Table 3.

TABLE 3
preparation of comb copolymers containing PCL1075 side chains

| | | | | | | | | 1 wt % |
|---|---|---|---|---|---|---|---|---|
| | | | | | | | LCST | Solubility RT |
| | | | | | Mn | | 1) in H₂O | 1) in H₂O |
| Ex. | r | q | p | s | g/mol | PD | 2) in 1% NaCl | 2) in 1% NaCl |
| A12 | 48 | 20 | 0 | 10 | 22.560 | 1.69 | <RT | emulsion |
| | | | | | | | <RT | emulsion |
| | | | | | | | | precip 60° C. |
| A13 | 48 | 20 | 0 | 10 | 22.690 | 1.78 | <RT | emulsion |
| | | | | | | | <RT | emulsion |
| | | | | | | | | precip 60° C. |
| A14 | 38 | 20 | 0 | 20 | 28.290 | 1.57 | <RT | emulsion |
| | | | | | | | <RT | emulsion |
| | | | | | | | | precip 60° C. |
| A15 | 38 | 20 | 0 | 30 | 31.700 | 1.44 | n.a. | not soluble |
| | | | | | | | n.a. | not soluble |
| A25 | 38 | 0 | 20 | 20 | 13.770 | 1.60 | 80° C. | clear |
| | | | | | | | <RT | emulsion |

Legend: r (mol units n-butylesters), q (mol units R1) MPEG 500, p (mol units R2) Lutensol ® ON 70, s (mol units R3) PCL 1075

### Example A18

### Poly(n-BA-co-MPEG500A-co-HEMOA)

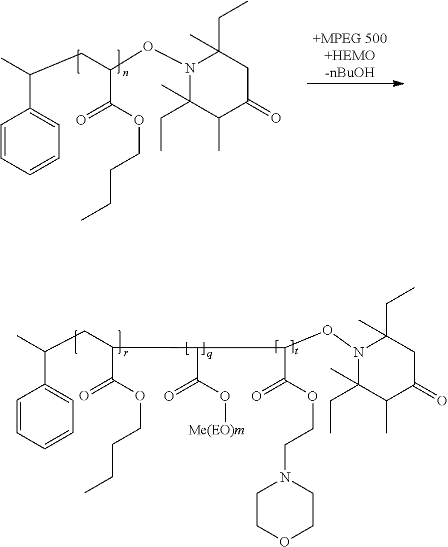

Co-Transesterification Using MPEG500 and HEMO

In a 100 mL flask equipped with an overhead propeller stirrer, distillation column with dry ice acetone cooling 27.0 g of poly(n-BA) according to example B1, 26.11 g of MPEG500 (Mn=500 g/mol, 20 mol % based on original amount of n-butylesters) and 3.42 g of HEMO (MW=131 g/mol, 10 mol % based on original amount of n-butylesters) are added and dried by degasing at 80° C. for 60 min at 80 mbara. The clear reaction mass in the flask is heated to 135° C. Four portions of 98 mg of LiOtBu are added during 6 h at 130-135° C. The formed n-butanol (ca. 5.8 g) is distilled off at reduced pressure (45 mbara).

49.0 g of poly(n-BA-co-MPEG500A-co-HEMOA) A18 are obtained as a brownish viscous liquid. Mn=11430 g/mol, PD=1.76. Analysis via GPC as well as 1H-NMR indicate >95% conversion of MPEG500. SC=98.2%.

The polymer A18 does not show an LCST below 85° C. in pure water, but an LCST of 60° C. in 1% NaCl.

### Examples A19 to A24

In analogous way as described for polymer A18, the polymers A19 to A24 containing HEMO are prepared with the molar ratios indicated in Table 4.

TABLE 4
preparation of comb copolymers containing HEMO side chains

| | | | | | | | | | 1 wt % |
|---|---|---|---|---|---|---|---|---|---|
| | | | | | | | | LCST | Solubility RT |
| | | | | | | | | 1) in H₂O | 1) in H₂O |
| | | | | | | Mn | | 2) in 1% | 2) in 1% |
| Ex. | r | q | p | s | t | g/mol | PD | NaCl | NaCl |
| A18 | 48 | 20 | 0 | 0 | 10 | 11.430 | 1.76 | >85° C. | clear |
| | | | | | | | | 60° C. | clear |
| A19 | 38 | 20 | 0 | 0 | 20 | 12.540 | 1.62 | >85° C. | clear |
| | | | | | | | | 65° C. | clear |
| A20 | 28 | 20 | 0 | 0 | 30 | 11.590 | 1.74 | >85° C. | clear |
| | | | | | | | | 70° C. | clear |
| A21 | 18 | 0 | 0 | 0 | 60 | 7.500 | 1.47 | <RT | emulsion |
| | | | | | | | | <RT | emulsion |
| A22 | 38 | 10 | 10 | 10 | 10 | 17.460 | 1.50 | <RT | emulsion |
| | | | | | | | | n.a | not soluble |
| A23 | 18 | 15 | 15 | 15 | 15 | 9.510 | 1.16 | <RT | emulsion |
| | | | | | | | | <RT | emulsion |
| A24 | 38 | 0 | 20 | 0 | 20 | 27.320 | 1.47 | <RT | emulsion |
| | | | | | | | | n.a | not soluble |

Legend: r (mol units n-butylesters), q (mol units R1) MPEG 500, p (mol units R2) Lutensol ® ON 70, s (mol units R3) PCL 1075, t (mol units R4) HEMO

### Example A26

### Poly(n-BA-co-SolketalA)

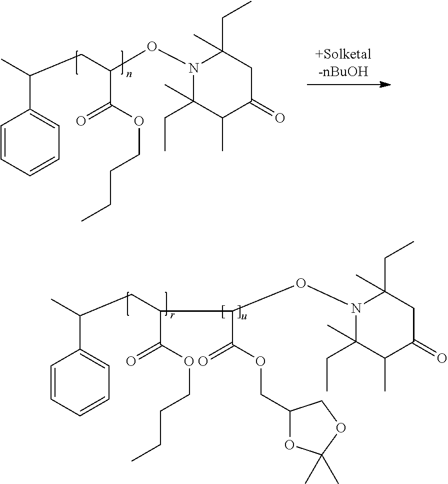

Transesterification using Solketal ((+/−)-2,2-Dimethyl-4-hydroxymethyl-1,3-dioxolane) In a 100 mL flask equipped with an overhead propeller stirrer, distillation column with dry ice acetone cooling 40.0 g of poly(n-BA) according to example B1 and 25.56 g of Solketal (Mn=132 g/mol, 50 mol % based on original amount of n-butylesters) are added and dried by degasing at 80° C. for 60 min at 80 mbara. The clear reaction mass in the flask is heated to 135° C. Five portions of 100 mg of LiOtBu are added during 13 h at 130-135° C. The formed n-butanol (ca. 14.3 g) is distilled off at reduced pressure (60 mbara).

43.1 g of poly(n-BA-co-SolketalA) A26 are obtained as a brownish viscous liquid. Mn=10470 g/mol, PD=1.57. The SC is determined at 96.9%. Analysis via GPC as well as 1H-NMR indicated full conversion of Solketal without unprotection of the diol.

The polymer A26 does not show solubility in pure water nor in 1% NaCl solution.

### Examples A27 to A31

In analogous way as described for polymer A26, the polymers A27 to A31 containing HEMO are prepared with the molar ratios indicated in Table 5.

TABLE 5
preparation of comb copolymers containing Solketal side chains

| | | | | | | | | 1 wt % |
|---|---|---|---|---|---|---|---|---|
| | | | | | | | LCST | Solubility RT |
| | | | | | Mn | | 1) in H₂O | 1) in H₂O |
| Ex. | r | q | t | u | g/mol | PD | 2) in 1% NaCl | 2) in 1% NaCl |
| A26 | 28 | 0 | 0 | 50 | 10.470 | 1.57 | n.a. | not soluble |
| | | | | | | | n.a. | not soluble |
| A27 | 28 | 0 | 0 | 50 | 11.560 | 1.83 | n.a. | not soluble |
| | | | | | | | n.a. | not soluble |
| A28 | 28 | 0 | 25 | 25 | 9.050 | 1.53 | n.a. | not soluble |
| | | | | | | | n.a. | not soluble |
| A29 | 58 | 10 | 0 | 10 | 11.740 | 1.54 | <RT | emulsion |
| | | | | | | | <RT | emulsion |
| A30 | 43 | 20 | 0 | 15 | 11.030 | 1.51 | >85° C. | clear |
| | | | | | | | 55° C. | clear |
| A31 | 28 | 30 | 0 | 20 | 9.920 | 1.45 | 75° C. | clear |
| | | | | | | | 65° C. | clear |

Legend: r (mol units n-butylesters), q (mol units R1) MPEG 500, t (mol units R4) HEMO, u (mol units R5) Solketal

### Example A32

### Deprotection of Poly(n-BA-co-MPEG500A-co-SolektalA) to Poly(n-BA-co-MPEG500A-co-glycerylA) with TFAA

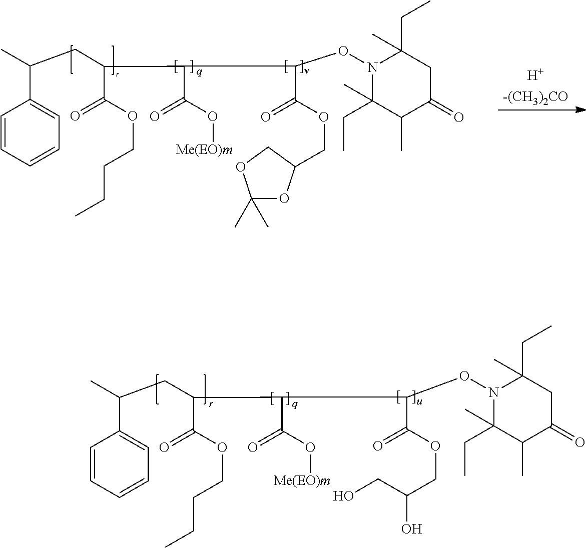

In a 100 mL flask equipped with an overhead propeller stirrer, 5.5 g of polymer according to example A30 is dissolved in 11.0 g of THF, 11.0 g of H₂O and 5.0 g of MeOH. At room temperature 1.1 g of trifluoroacetic anhydride (MW=230) is added, followed by heating to 80° C. and stirring the contents for 18 h. The resulting brownish solution is analyzed by NMR to ensure that all acetal groups have disappeared. The polymer solution is concentrated under reduced pressure (100 mbara) to a SC of 94.5% to yield 4.5 g of a viscous brownish liquid. Mn=10770 g/mol, PD=1.50. 1H-NMR indicated full deprotection of Solketal units.

The polymer A32 shows an LOST of 55° C. in pure water and 50° C. in a 1% NaCl solution.

### Example A35

### Deprotection of Poly(n-BA-co-MPEG500A-co-SolektalA) to Poly(n-BA-co-MPEG500A-co-glycerylA) with Dowex

In a 100 mL flask equipped with an overhead propeller stirrer, 5.55 g of polymer according to example A29 is dissolved in 11.1 g of THE, 11.1 g of H₂O and 5.0 g of EtOH. At room temperature 1.1 g of DOWEX 50WX8 (acidic resin) is added, followed by heating to 80° C. and stirring the contents for 18 h. To the resulting brownish solution another portion of DOWEX 50WX8 is added (1.1 g) followed by 1.0 g of H₂O. After another 18 h of stirring at 80° C., the polymer solution is filtered and concentrated under reduced pressure (100 mbara) to a SC of 98.8% to yield 4.3 g of a viscous brownish liquid. Mn=13200 g/mol, PD=1.62. 1H-NMR indicated full deprotection of Solketal units. The polymer A35 becomes an emulsion in both pure water and 1% NaCl solution.

### Example A37

### Deprotection of Poly(n-BA-co-MPEG500A-co-SolektalA) to Poly(n-BA-co-MPEG500A-co-glycerylA) with a combination of TFAA and PTSA

In a 100 mL flask equipped with an overhead propeller stirrer, 12.5 g of polymer according to example A31 is dissolved in 6.5 g of THF, 0.65 g of H₂0 and 6.0 g of EtOH. At room temperature 0.185 g of trifluoroacetic anhydride (MW=230) and 0.75 g of para-toluenesulfonic acid monohydrate (MW=190) are added, followed by heating to 80° C. and stirring the contents for 18 h. Another portion of PTSA and TFAA (same amounts) and 2.0 g of water are added and stirred for another 18 h at 80° C. Finally, the polymer solution is concentrated under reduced pressure (100 mbara) to a SC of 96.5% to yield 10.9 g of a viscous brownish liquid. Mn=8670 g/mol, PD=1.49. 1H-NMR indicated full deprotection of Solketal units.

The resulting polymer shows an LCST of 55° C. in pure water and 50° C. in 1% NaCl solution.

### Examples A33 to A38

In analogous way as described for polymer A32, the polymers A33 to A38 are prepared from their precursors in Table 6.

TABLE 6
preparation of comb copolymers containing gylceryl side chains

| | | | | | | | | LCST | 1 wt % |
|---|---|---|---|---|---|---|---|---|---|
| | | | | | | | | 1) in H₂O | Solubility RT |
| | | | | | Conditions | Mn | | 2) in 1% | 1) in H₂O |
| Ex. | precursor | r | q | u | of example | g/mol | PD | NaCl | 2) in 1% NaCl |
| A32 | A30 | 43 | 20 | 15 | A32 with | 10.770 | 1.50 | 55° C. | clear |
| | | | | | TFAA | | | 50° C. | clear |
| A33 | A31 | 28 | 30 | 20 | A32 with | 7.810 | 1.41 | 60° C. | clear |
| | | | | | TFAA | | | 55° C. | clear |
| A35 | A29 | 60 | 10 | 8 | A35 with | 13.200 | 1.62 | RT | emulsion |
| | | | | | Dowex | | | RT | emulsion |
| A37 | A31 | 28 | 30 | 20 | A32 with | 8.670 | 1.49 | 60° C. | clear |
| | | | | | TFAA/PTSA | | | 55° C. | clear |
| A38 | A31 | 30 | 30 | 18 | A35 with | 9.050 | 1.24 | 65° C. | clear |
| | | | | | Dowex | | | 65° C. | clear |

Legend: r (mol units n-butylesters), q (mol units R1) MPEG 500, u (mol units R5) Glyceryl

### Example A34

### Preparation of Poly(n-BA-co-HEMO[H⁺]A-co-glycerylA)

In a 100 mL flask equipped with an overhead propeller stirrer, 5.55 g of polymer according to example A28 is dissolved in 11.1 g of THF, 11.1 g of H₂O and 5.0 g of EtOH. At room temperature 1.1 g of TFAA (MW=230) is added, followed by heating to 80° C. and stirring the contents for 18 h. The polymer solution is concentrated under reduced pressure (100 mbara) to a SC of 95.5% to yield 5.1 g of a highly viscous brownish liquid. Mn=5340 g/mol, PD=2.16. 1H-NMR indicates full deprotection of Solketal units, part of the HEMO groups (25%) are obtained as trifluroacetates.

The polymer A34 has an LCST above 85° C. in both pure water and 1% NaCl solution, while the starting polymer A28 does not show solubility in both media.

### Example A39

### Preparation of Poly(n-BA-co-HEMOquat[⁺]A-co-glycerylA)

In a 100 mL flask equipped with an overhead propeller stirrer, 5.0 g of polymer according to example A18 is dissolved in 10.0 g of H₂O, and 1.42 g of ethylbromide (MW 109, 50 mol % relative to HEMO units) is added at room temperature. The clear solution is stirred for 6 h at RT, and subsequently filled in a glass jar without further elaboration (yield 15.97 g). The solid content is 28.5%. Due to insolubility of the quaternized polymer in THF, GPC analysis cannot not be performed.

The polymer A39 has an LOST above 85° C. in both pure water and a 1% NaCl solution.

### Example A40

In analogous way as described for polymer A39, the polymer A40 is prepared from example A21 as indicated in Table 7.

TABLE 7
preparation of comb copolymers containing HEMO groups quaternized with
ethylbromide

| | | | | | | | | 1 wt % |
|---|---|---|---|---|---|---|---|---|
| | | | | | Level of | | LCST | Solubility RT |
| | | | | | quaternization | SC of | 1) in H₂O | 1) in H₂O |
| Ex. | precursor | r | q | u | of units u | solution | 2) in 1% NaCl | 2) in 1% NaCl |
| A39 | A18 | 48 | 20 | 10 | 50 mol % | 28.5 wt % | >85° C. | clear |
| | | | | | EtBr | | >85° C. | clear |
| A40 | A21 | 18 | 0 | 60 | 8.3 mol % | 19.5 wt % | n.a. | 2 phases |
| | | | | | EtBr | | n.a. | |

Legend: r (mol units n-butylesters), q (mol units R1) MPEG 500, u (mol units R4) HEMO

### Example A51

### Poly(n-BA-co-MPEG500A-co-LuN400A)

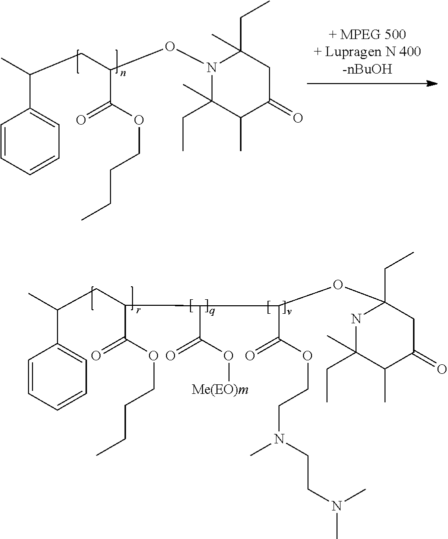

Co-transesterification Using MPEG500 and Lupragen® N 400

In a 100 mL flask equipped with an overhead propeller stirrer, distillation column with dry ice acetone cooling 27.0 g of poly(n-BA) according to example B1, 26.11 g of MPEG500 (Mn=500 g/mol, 20 mol % based on original amount of n-butylesters) and 3.82 g of Lupragen® N 400 (Mn 146 g/mol, 10 mol % based on original amount of n-butylesters) are added and dried by degasing at 70° C. for 60 min at 100 mbara. The clear reaction mass in the flask is heated to 135° C. Four portions of 100 mg of LiOtBu are added during 6 h at 130-135° C. The formed n-butanol (ca. 5.8 g) is distilled off at reduced pressure (80 mbara).

48.57 g of poly(n-BA-co-MPEG500A-co-LuN400A) are obtained as a brownish viscous liquid. Mn=16760 g/mol, PD=1.88. Analysis via GPC as well as 1H-NMR indicate >95% conversion of the MPEG-OH and aminoalcohol. SC=97.8%.

### Examples A52 to A54

In analogous way as described for polymer A51, the polymers A52 to A54 containing Lupragen N 400 are prepared with the molar ratios indicated in Table 8.

TABLE 8
preparation of comb copolymers
containing Lupragen N 400 side chains

| Ex. | r | q | v | Mn g/mol | PD |
|---|---|---|---|---|---|
| A51 | 48 | 20 | 10 | 16.760 | 1.88 |
| A52 | 58 | 20 | 30 | 12.520 | 2.17 |
| A53 | 48 | 0 | 30 | 8.170 | 1.97 |
| A54 | 38 | 0 | 40 | 7.770 | 1.95 |

Legend: r (mol units n-butylesters), q (mol units R1) MPEG 500, v (mol units R2) Lupra-gen ® N 400

### Example B3

### Synthesis of a Linear Block Copolymer Poly(nBA-b-4VP)

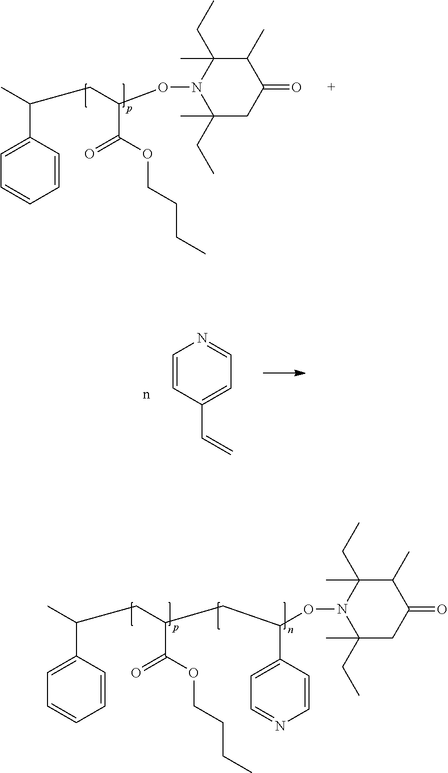

In a 3-necked 500 mL round bottom flask with magnetic stirring bar, cooler and thermometer, 214.18 g of poly(n-BA) according to example B1 with a polymerization degree of 74 units of nBA (by 1H NMR), 70.90 g of 4-vinylpyridine (4VP, MW=105 g/mol) and 79.70 g of MPA are added, three times degassed with N₂/vacuum and polymerized at 125° C. under N₂ for 8 h. Residual monomers and solvents are distilled off at 80° C. and 12 mbara until a SC of >98% is reached, and subsequently diluted to a SC of 80° A with 60.0 g of MPA to yield B3 (302.2 g) as a viscous yellowish-orange liquid. A small sample of the solvent-free polymer is analyzed by GPC (THF, PS-Standard, Mn=8600 g/mol, PD=1.24). The block lengths are determined by 1H NMR as 73 units of nBA and 15 units of 4VP.

### Example C1

### Poly([n-BA-co-MPEG500A]-b-4VP)

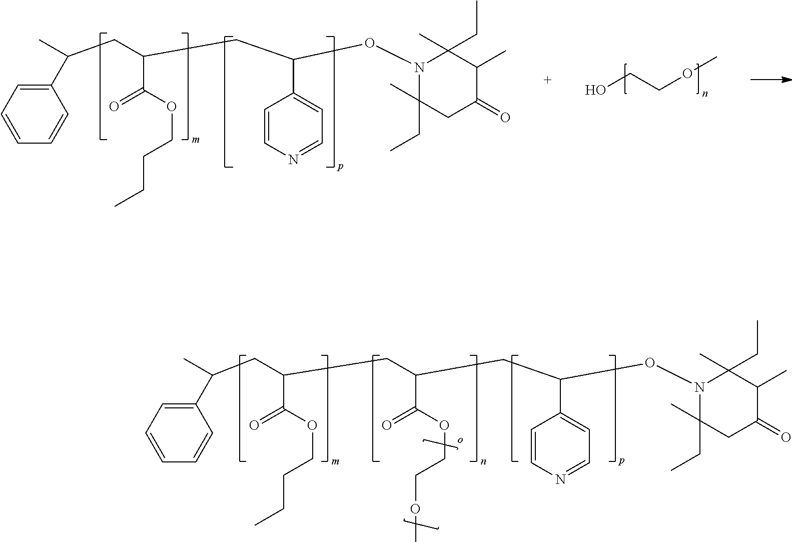

In a 350 flask equipped with a magnetic stirring bar, distillation column with dry ice acetone cooling 150.0 g of poly(n-BA-b-4VP) in MPA, prepared according to example B3 (80% solids) is mixed with 80.0 g of MPEG 500. At 90° C., the solvent is distilled off at reduced pressure, and further heated to 130° C. under vacuum (20 mbara) for one hour to remove traces of humidity. Three portions of 800 mg of LiOtBu are added during 6 h at 115-130° C. The formed n-butanol (ca. 11.8 g) is distilled off at reduced pressure (20 mbara). The final product (188.2 g, brownish liquid) is diluted to 50 wt % with H₂O. Analysis via GPC as well as 1H-NMR indicate complete conversion of the MPEG500. GPC: Mn=9120 g/mol, PD=1.87.

Polymer C1 is a clear solution in water (10 wt %) at room temperature and showed an LOST above 65° C.

### Examples C2 to C4

In analogous way as described for polymer C1, the block polymers C2 to C4 containing MPEG 500 were prepared with the molar ratios indicated in Table 9.

TABLE 9
preparation of block copolymers containing MPEG500 side chains

| | | | | Mn | | LCST | 10 wt % Solubility |
|---|---|---|---|---|---|---|---|
| Ex. | m | n | p | g/mol | PD | in H₂O | RT in H₂O |
| C1 | 58 | 15 | 15 | 9.120 | 1.87 | 65° C. | clear |
| C2 | 45 | 28 | 15 | 8.960 | 1.81 | 83° C. | clear |
| C3 | 33 | 40 | 15 | 9.260 | 1.58 | >85° C. | clear |
| C4 | 23 | 50 | 15 | 6.360 | 1.61 | >85° C. | clear |

Legend: m (mol units n-butylesters), n (mol units) MPEG 500, p (mol units) 4VP

### B) Application Results

Testing of the Soil Release Effect of the Comb Copolymers According to the Invention in Detergents

A cloth of 5 g white polyester fabric (WfK 30A) is treated in 100 ml of wash liquor. The liquor contains water of 16° C. German hardness, a standard washing agent (AATCC 2003 Standard Liquid Reference Detergent WOB Order No. 08804) in a concentration of 4.7 g/l and optionally 0.094 g/L of one of the active polymers of the invention. The treatment is carried out in a steel beaker in a LINITEST apparatus for 30 minutes at 40° C. Afterwards the textiles are rinsed under running tap water, spin dried and dried for 30 min at 45° C. This procedure is repeated 2 times (thus 3 pre-wash cycles in total) with the same cloth but with fresh wash liquor.

Subsequently the cloths are let acclimatize for 2 h at room temperature and are then each soiled with 50 μL of dirty motor oil, which is applied by a pipette. The stains are let dried overnight at room temperature. The next day the CIE lightness Y of the stains is measured with a GRETAG SPM100 remission spectrometer. Subsequently each soiled cloth is washed in a Linitest beaker in 100 ml wash liquor under the same conditions and in the same wash liquor composition as described above for the pre-wash cycle. Subsequently the cloths are dried for 30 min. at 45° C. and let acclimatize for 2 h at room temperature before the lightness Y of the stain stains is measured.

The difference in lightness Y of the dirty motor oil stains before and after washing is denoted DY and gives a measure of the washing performance of the wash liquor. The DY values for several polymers of the types A, B or C are shown in Table B1.

TABLE B1
Performance results
in soil release test

| Polymer | DY |
|---|---|
| No polymer | 13.1 |
| (reference) | |
| C1 | 15.7 |
| A1 | 19.4 |
| A7 | 15.9 |
| A12 | 19.3 |
| A18 | 15.0 |
| A21 | 20.0 |
| A22 | 16.8 |
| A39 | 16.1 |
| A40 | 17.6 |
| A51 | 21.2 |
| A52 | 19.1 |
| A53 | 19.6 |
| A54 | 19.8 |

A significant increase in the lightness improvement DY of the dirty motor oil stains is observed for the copolymers of the invention.

Testing of the Anti-Redeposition Effect of the Copolymers of the Invention in Detergents.

A wash liquor is prepared containing water of 16° German hardness, a standard washing agent (AATCC 2003 Standard Liquid Reference Detergent WOB Order No. 08804) in a concentration of 4.7 g/l, soot (Corax N765) in a concentration of 0.03 g/L and optionally 0.075 g/L of one of the active polymers of the invention. The wash liquors are first stirred with a magnetic stirrer for 10 min, subsequently treated in a ultrasonic bath for 10 min. and finally again stirred for 10 min with a magnetic stirrer. Under stirring 100 g of the wash liquor is filled into a beaker of a Linitest apparatus, a cloth of 5 g white cotton fabric (WfK 13AK) is added. The beakers are closed and the white cotton is treated for 30 min at 40° C. in the wash liquor. Afterwards the textiles are rinsed under running tap water, spin dried and dried for 30 min at 45° C. This procedure is repeated 2 times (thus 3 wash cycles in total) with the same cotton cloth but with fresh wash liquor and fresh soot. Subsequently the CIE lightness Y of the cloths is measured with a DATA-COLOR Spectra Flash SF500 remission spectrometer.

The lightness Y of cotton cloths after the three wash cycles is a measure for the antiredeposition performance of the wash liquor, containing an inventive copolymer. When the cloths are washed in the same manner but without adding soot, the cloths have a lightness Y of about 89.

The Y values for several polymers of the types A, B or C are shown in Table B2.

TABLE B2
Performance results
in soil release test

| Polymer | Y (after) |
|---|---|
| No polymer | 67.4 |
| (reference) | |
| Sodium | 72.5 |
| carboxymeth- | |
| ylcellulose | |
| C1 | 76.8 |
| C2 | 76.1 |
| C4 | 75.2 |
| A1 | 73.5 |
| A12 | 78.3 |
| A20 | 74.1 |
| A39 | 70.9 |
| A51 | 70.4 |

A significant increase in the lightness Y of the cotton cloths after three wash cycles is observed for the wash liquors containing polymers of the invention. In many cases even a significant improvement over sodium carboxymethylcellulose, the current state of the art, is observed.

1.-5. (canceled)

6. Use of one or more comb or block copolymers as soil antiredeposition agents and soil release agents in aqueous laundry processes where the comb or block copolymers have been prepared in a first step
a) by controlled free radical polymerization of a C₁-C₁₀ alkyl ester of acrylic or methacrylic acid and optionally one or more monomers without an ester bond; and in a second step
b) modified in a polymer analogous transesterification reaction with a primary or secondary alcohol
to form a comb or block copolymer; and
wherein the comb or block copolymer has been prepared in step a) from n-butylacrylate and optionally from one or more monomers without an ester bond;
and wherein the monomer without an ester bond is selected from the group consisting of 4-vinyl-pyridine, 2-vinyl-pyridine, vinyl-imidazole vinyl-pyrrolidone, dimethylacrylamide, 3-dimethylaminopropylmethacrylamide, styrene, α-methyl styrene, p-methyl styrene or p-tert-butyl-styrene and acrylonitrile;
and wherein the primary alcohol of step b) is
an ethoxylate of formula (A)
R_{A}-[O—CH₂—CH₂—]ₙ—OH (A)
wherein R_{A} is saturated or unsaturated, linear or branched chain alkyl with 1-22 carbon atoms, or alkylaryl or dialkylaryl with up to 24 carbon atoms and n is 1 to 150;
a polydimethylsilicone oligomer of formula (B) 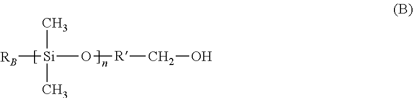
wherein R_{B} is C₁-C₁₈alkyl, phenyl or C₇-C₁₅aralkyl; n is 1 to 50 and R′ is a linking group with 1 to 20 carbon atoms;
a partly or fully fluorinated primary alcohol;
a C₈ to C₆₀alkyl linear or branched primary or secondary alcohol;
a racemic mixture of 2,2-dimethyl-4-hydroxymethyl-1,3-dioxolane;
a primary or secondary alcohol containing at least one tertiary amine group;
N,N,N′-Trimethylaminoethylethanolamin,
4-hydroxyethyl-pyridine and N-hydroxyethylmorpholine or
a primary alcohol whose chain is interrupted by at least one ester group such as polycaprolactone α-acetyloxy, -ω-hydroxy with a molecular weight from 750 to 2500 g/mol.

7. Use according to claim 6 wherein the comb or block copolymer has a polydispersity, PD from 1.0 to 2.5.

8. Use according to claim 6 wherein the comb or block copolymer has amphiphilic properties.

9. A method for preventing soil re-deposition on textiles and for soil release from textiles during an aqueous laundry process, which method comprises applying a comb or block copolymer which has been prepared in a first step
a) by controlled free radical polymerization of a C₁-C₁₀ alkyl ester of acrylic or methacrylic acid and optionally one or more monomers without an ester bond; and in a second step
b) modified in a polymer analogous transesterification reaction with a primary or secondary alcohol
to form a comb or block copolymer; and
wherein the comb or block copolymer has been prepared in step a) from n-butylacrylate and optionally from one or more monomers without an ester bond;
and wherein the monomer without an ester bond is selected from the group consisting of 4-vinyl-pyridine, 2-vinyl-pyridine, vinyl-imidazole, vinyl-pyrrolidone, dimethylacrylamide, 3-dimethylaminopropylmethacrylamide, styrene, α-methyl styrene, p-methyl styrene or p-tert-butyl-styrene and acrylonitrile;
and wherein the primary alcohol of step b) is
an ethoxylate of formula (A)
R_{A}-[O—CH₂—CH₂-]ₙ—OH (A)
wherein R_{A} is saturated or unsaturated, linear or branched chain alkyl with 1-22 carbon atoms, or alkylaryl or dialkylaryl with up to 24 carbon atoms and n is 1 to 150;
a polydimethylsilicone oligomer of formula (B) 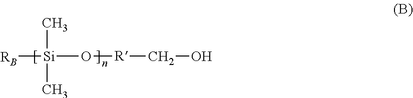
wherein R_{B} is C₁-C₁₈alkyl, phenyl or C₇-C₁₅aralkyl; n is 1 to 50 and R′ is a linking group with 1 to 20 carbon atoms;
a partly or fully fluorinated primary alcohol;
a C₈ to C₆₀alkyl linear or branched primary or secondary alcohol;
a racemic mixture of 2,2-dimethyl-4-hydroxymethyl-1,3-dioxolane;
a primary or secondary alcohol containing at least one tertiary amine group;
N,N,N′-Trimethylaminoethylethaolamin,
4-hydroxyethyl-pyridine and N-hydroxyethylmorpholine or
a primary alcohol whose chain is interrupted by at least one ester group such as polycaprolactone α-acetyloxy, -ω-hydroxy with a molecular weight from 750 to 2500 g/mol.

10. Detergent compositions comprising:
I) from 1 to 50 wt-%, based on the total weight of the composition, A) of at least one surfactant;
II) from 0 to 70 wt-%, based on the total weight of the composition, B) of at least one builder substance;
III) from 0-30 wt-%, based on the total weight of the composition, C) of at least one peroxide and/or one peroxide-forming substance;
IV) from 0.05 to 10 wt.-%, preferably 0.05 to 5 wt %, more preferably 0.1 to 4 wt % based on the total weight of the composition, D) of at least one comb or block copolymer have been prepared in a first step
a) by controlled free radical polymerization of a C₁-C₁₀ alkyl ester of acrylic or methacrylic acid and optionally one or more monomers without an ester bond; and in a second step
b) modified in a polymer analogous transesterification reaction with a primary or secondary alcohol
to form a comb or block copolymer; and
wherein the comb or block copolymer has been prepared in step a) from n-butylacrylate and optionally from one or more monomers without an ester bond;
and wherein the monomer without an ester bond is selected from the group consisting of 4-vinyl-pyridine, 2-vinyl-pyridine, vinyl-imidazole, vinyl-pyrrolidone, dimethylacrylamide, 3-dimethylaminopropylmethacrylamide, styrene, α-methyl styrene, p-methyl styrene or p-tert-butyl-styrene and acrylonitrile;
and wherein the primary alcohol of step b) is
an ethoxylate of formula (A)
R_{A}-[O—CH₂—CH₂-]ₙ—OH (A)
wherein R_{A} is saturated or unsaturated, linear or branched chain alkyl with 1-22 carbon atoms, or alkylaryl or dialkylaryl with up to 24 carbon atoms and n is 1 to 150;
a polydimethylsilicone oligomer of formula (B) 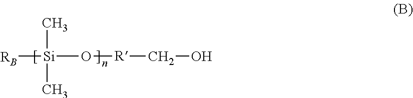
wherein R_{B} is C₁-C₁₈alkyl, phenyl or C₇-C₁₅aralkyl; n is 1 to 50 and R′ is a linking group with 1 to 20 carbon atoms;
a partly or fully fluorinated primary alcohol;
a C₈ to C₆₀alkyl linear or branched primary or secondary alcohol;
a racemic mixture of 2,2-dimethyl-4-hydroxymethyl-1,3-dioxolane;
a primary or secondary alcohol containing at least one tertiary amine group;
N,N,N′-Trimethylaminoethylethanolamin,
4-hydroxyethyl-pyridine and N-hydroxyethylmorpholine or
a primary alcohol whose chain is interrupted by at least one ester group such as polycaprolactone α-acetyloxy, -ω-hydroxy with a molecular weight from 750 to 2500 g/mol.;
V) from 0-60 wt-%, based on the total weight of the composition, E) of at least one further additive;
VI) From 0-90 wt %, based on the total weight of the composition, F) water.
